(19) United States
(12) Patent Application Publication
(10) Pub. No.: US 2025/0153245 A1
(43) Pub. Date: May 15, 2025

(54) PREPARATION METHOD FOR TITANIUM-BASED AMORPHOUS SPHERICAL POWDER

(71) Applicant: Zhengzhou Research Institute of Mechanical Engineering Co,Ltd., Zhengzhou (CN)

(72) Inventors: Li BAO, Zhengzhou (CN); Jia MA, Zhengzhou (CN); Guangkuo AO, Zhengzhou (CN); Qi YU, Zhengzhou (CN); Xudong SI, Zhengzhou (CN); Hongtao YANG, Zhengzhou (CN); Sishuo CHEN, Zhengzhou (CN)

(73) Assignee: Zhengzhou Research Institute of Mechanical Engineering Co, Ltd., Zhengzhou (CN)

(21) Appl. No.: 19/019,843

(22) Filed: Jan. 14, 2025

Related U.S. Application Data
(63) Continuation of application No. PCT/CN2024/071756, filed on Jan. 11, 2024.

(30) Foreign Application Priority Data
Apr. 28, 2023 (CN) 202310489804.1

(51) Int. Cl. B22F 9/14; B22F 1/065

(52) U.S. Cl. CPC B22F 9/14; B22F 1/065; B22F 2301/205

(57) ABSTRACT

Disclosed is a preparation method for titanium-based amorphous spherical powder, including treating a titanium-based brazing filler metal by means of plasma rotating electrode process (PREP) atomization, where argon and helium are used as a protective gas for the PREP atomization. According to this solution, PREP atomization is used, and argon and helium are used in combination as a protective gas, thereby effectively increasing the cooling velocity required by titanium-based amorphous powder that can be achieved in this process and thus significantly improving the preparation success rate and purity of the titanium-based amorphous powder. The applicant finds that when argon and helium are used in combination as a protective gas, the thermal conductivity coefficient of the mixed gas is effectively improved, such that that the cooling rate is increased, and the success rate of preparing the titanium-based amorphous spherical powder by means of PREP atomization is fully improved.

### CROSS-REFERENCE TO RELATED APPLICATIONS

The application claims priority to Chinese patent application No. 202310489804.1, filed on Apr. 28, 2023, the entire contents of which are incorporated herein by reference.

### TECHNICAL FIELD

The present disclosure relates to the technical field of amorphous alloy preparation methods, and in particular to a preparation method for titanium-based amorphous spherical powder.

### BACKGROUND

Titanium and titanium alloys are widely applied to aerospace and maritime equipment due to their excellent heat resistance, corrosion resistance, and fatigue resistance. To ensure reliable and corrosion-resistant precision connections between titanium and titanium alloy components, a titanium-based brazing filler metal is usually used for welding them. Main components of the titanium-based brazing filler metal are Ti and Zr, where Ti and Zr have similar properties and are infinitely soluble in each other, and Ti and Zr have relatively high temperatures. To lower a melting point, other elements are added to the alloy, which enables to prepare the titanium-based brazing filler metal. Various elements in the titanium-based brazing filler metal easily form a large number of intermetallic compounds, which are hard and brittle and difficult to be processed into strips or ribbons. Moreover, Ti and Zr elements are prone to segregation in the brazing filler metal, thereby affecting a welding effect.

In order to avoid the segregation of components in the brazing filler metal that will affect the welding effect, in view of characteristics of titanium-based amorphous alloys such as single phase, uniform composition, no dislocation and crystal defects, the titanium-based amorphous alloys can be used in a brazing process of titanium and titanium alloys to effectively avoid compositional segregation, reduce corrosion and obtain reliable welding joints. Therefore, the titanium-based brazing filler metal can be welded in an amorphous alloy state. Moreover, for the precision connections between complex and thin-walled components made of titanium and titanium alloys, the titanium-based brazing filler metal needs to be assembled in the powder or paste form due to higher requirements for the titanium-based brazing filler metal. Spherical powder has significant advantages over strip-shaped crystalline brazing filler metals due to their high bulk density, weak overlapping effect during use, and minimal impact on welding.

In order to solve the above problems, currently available conventional methods for preparing titanium-based powder (not titanium-based amorphous powder) can be adopted, including electrode induction melting gas atomization (EIGA) and plasma rotating electrode process (PREP) atomization. However, the methods of the prior art for preparing the titanium-based powder still have the following technical defects: (1) For the EIGA, an inert gas (argon) is used at a pressure of 3-6 MPa, resulting in a relatively low gas efflux velocity and a poor heat removal efficiency, and a cooling rate generally does not exceed 10² K/s, which does not meet cooling rate conditions for forming amorphous powder. (2) For the PREP, a low rotation velocity of powder production leads to a larger powder particle size and a low relative velocity of powder ejection, thereby weakening a capacity of forming amorphous powder from alloy powder; and thermal conductivity and cooling rate of argon as a protective and cooling medium do not meet critical cooling conditions for amorphous formation.

To sum up, titanium-based amorphous spherical powder cannot be prepared in the prior art. Therefore, there is an urgent need to develop a preparation method for titanium-based amorphous spherical powder with a high success rate and excellent properties, and the method can be used to prepare the titanium-based amorphous spherical powder from the titanium-based brazing filler metal. The present disclosure not only effectively makes up for the defects of the methods of the prior art for preparing amorphous alloy powder, but also is of great significance for the wide application of the titanium-based amorphous powder.

### SUMMARY

An objective of the present disclosure is to provide a preparation method for titanium-based amorphous spherical powder, so as to solve the technical problem that the titanium-based amorphous spherical powder cannot be prepared in the prior art.

In order to realize the above objective, the present disclosure provides a technical solution as follows: a preparation method for titanium-based amorphous spherical powder, including treating a titanium-based brazing filler metal by means of plasma rotating electrode process (PREP) atomization, where argon and helium are used as a protective gas for the PREP atomization.

A principle of the solution is as follows:

The PREP atomization is a commonly used centrifugal atomization technology for producing high-purity spherical titanium powder, and its basic principle is shown in FIG. 1. In a protective gas environment, an end face of a consumable electrode is melted into a liquid film by a plasma arc, and is thrown out at high velocity to form droplets under the action of a rotational centrifugal force, and then the droplets are spheroidized and condensed into spherical powder under the action of surface tension. However, formation of amorphous powder directly depends on a critical cooling rate when melt alloy is cooled. When an external cooling rate is higher than the critical cooling rate of the alloy and when the melt alloy reaches a solidification temperature, its internal atoms are frozen near a position where they are in a liquid state before they are crystallized, thereby forming an amorphous solid with an amorphous structure; and that is, when the external cooling rate is high enough, the alloy can form the amorphous powder.

The advantages of this solution are as follows:
1. In view that titanium-based amorphous powder cannot be prepared in the prior art, the PREP atomization is used in this solution, and argon and helium are used in combination as a protective gas, thereby effectively increasing the cooling velocity required by titanium-based amorphous powder that can be achieved in this process and thus significantly improving the preparation success rate and purity of the titanium-based amorphous powder. By means of long-term experiments, the applicant finds that when argon and helium are used in combination as a protective gas, a thermal conductivity coefficient of a mixed gas is effectively improved, so that the cooling rate can reach 6.35×10⁴ K/s, which meets requirements of the critical cooling rate of 10³-10⁴ K/s for titanium-based bulk amorphous alloy, and a success rate of preparing the titanium-based amorphous spherical powder by means of the PREP atomization is fully improved.
2. In view that non-spherical powder and satellite powder are easily generated when electrode induction melting gas atomization (EIGA) of the prior art is used for preparing titanium-based powder, the PREP atomization is adopted in this solution for preparing the amorphous spherical powder. By means of consumable electrode rotation, prepared powder has high purity, and hollow powder and satellite powder particles will not be formed due to an “umbrella effect” caused by different powder particle sizes similar to that generated when a gas atomization method of the prior art is adopted, thereby significantly improving quality of the prepared titanium-based amorphous powder and ensuring an application of the titanium-based amorphous spherical powder in related fields.

Preferably, a concentration of argon in the protective gas is 10-50%.

The beneficial effect of the present disclosure lies in that by mixing argon and helium according to the solution, the cooling rate in an environment of the consumable electrode made of the titanium-based brazing filler metal is fully improved, thereby ensuring to meet external requirements of atomizing the titanium-based brazing filler metal into the amorphous spherical powder, and improving the success rate. Moreover, the applicant has found through long-term experiments that when the concentration of argon in the protective gas is 10-50%, the titanium-based amorphous powder can be successfully prepared, and the obtained amorphous spherical powder has high purity and a concentrated particle size. When the concentration of argon is lower than 10%, a concentration of helium in the protective gas is too high, resulting in that plasma arcing is difficult and the titanium-based amorphous powder cannot be prepared. When the concentration of argon is higher than 50%, the success rate will be reduced because the cooling rate cannot meet cooling rate requirements for the titanium-based amorphous powder, which is specifically manifested in that the prepared powder has a high content of crystalline powder, and a particle size range of the amorphous powder is too broad, thereby resulting in formation of the hollow powder and satellite powder particles, and affecting an application of the titanium-based amorphous powder.

Preferably, the gas atomization of the titanium-based brazing filler metal is specifically completed in a box body, and the argon and helium are mixed before being filled into the box body.

Beneficial effects: according to this solution, the argon and helium are pre-mixed to form the mixed gas, which effectively enhances uniformity of the mixed gas, thereby ensuring uniform thermal conductivity of the mixed gas in various spaces in the box body, improving particle size uniformity of the prepared titanium-based amorphous spherical powder, and further ensuring properties and quality of the amorphous spherical powder.

Preferably, the titanium-based brazing filler metal is a bar material with a diameter of 60-90 mm.

Preferably, a rotation velocity of the bar material for the PREP atomization is greater than 25500 rpm.

Beneficial effects: according to this solution, an initial velocity at which powder is thrown out of the bar material can be effectively increased by increasing the rotation velocity of the bar material, thereby reducing a particle size of the prepared titanium-based amorphous powder.

Preferably, a linear velocity of the bar material for the PREP atomization is greater than 80 m/s.

Beneficial effects: for the PREP atomization, the faster rotation velocity of the PREP atomization indicates a smaller droplet diameter d, and however, a too high rotation velocity not only poses certain safety risks, but also significantly increases an operating energy consumption of equipment, thereby reducing production efficiency. According to this solution, the rotation velocity at which the amorphous spherical powder is formed from the bar material can be effectively reduced by limiting a diameter of the titanium-based brazing filler metal, thereby effectively lowering conditions and energy consumption for preparing the titanium-based brazing filler metal into the titanium-based amorphous spherical powder, improving production efficiency, effectively reducing potential safety hazards of high-velocity rotation, and enhancing production safety.

Preferably, the titanium-based brazing filler metal includes Ti, Zr and M, where the M is a combination of two or three of Cu, Ni, Be, Ag, Sn, Si, Hf and Al, and a relative melting point offset J of the titanium-based alloy is ≥0.2.

Beneficial effects: an amorphous forming ability of the alloy can be expressed by J, which represents a relative offset of the melting point, and a calculation formula is

$$J = \frac{{T}_{m}^{mix} - {T}_{m}}{{T}_{m}^{mix}} ,$$

where Tₘ is a melting point of the alloy, and Tₘ^{mix} is a mixed melting point; a calculation formula of Tₘ ^{mix} is

$${T}_{m}^{mix} = {\sum }_{i = 1}^{n} {n}_{i} {T}_{m}^{i} ,$$

where nᵢ is a molar fraction of an i^{th} element in a multi-element alloy system; and Tₘⁱ is a melting point of the i^{th} element in the multi-element alloy system. By means of experiments, the applicant finds that the relative melting point offset J of the titanium-based alloy is ≥0.2, and the alloy easily forms an amorphous alloy.

Preferably, a total mass percentage of Ti and Zr in the titanium-based brazing filler metal is greater than 50%.

Beneficial effects: by means of experiments, the applicant finds that when the total mass percentage of Ti and Zr in the titanium-based brazing filler metal is greater than 50%, the relative melting point offset of the titanium-based alloy is always greater than or equal to 0.2, which facilitates preparation of the titanium-based alloy that easily forms the amorphous powder.

### BRIEF DESCRIPTION OF DRAWINGS

FIG. 1 is a schematic diagram illustrating a principle of plasma rotating electrode process (PREP) atomization of the present disclosure.

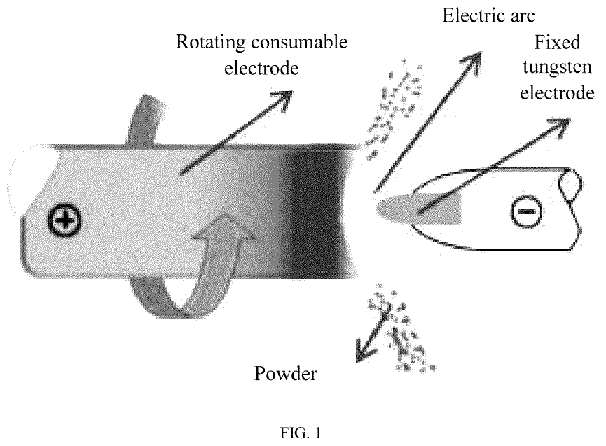

FIG. 2 is a scanning electron microscope diagram of titanium-based amorphous powder prepared in Example 1 of the present disclosure.

FIG. 3 is an XRD spectrogram of titanium-based amorphous powder prepared in Example 1 of the present disclosure.

FIG. 4 is an XRD spectrogram of titanium-based powder prepared in Comparative Example 1 of the present disclosure.

### DETAILED DESCRIPTION OF THE EMBODIMENTS

The present disclosure will be further described in detail below by means of specific embodiments, but the embodiments of the present disclosure are not limited thereto. Unless otherwise specified, technical means used in the following embodiments are conventional means well known to those skilled in the art; experimental methods used are all conventional methods; and materials, reagents and the like can all be obtained commercially.

### Example 1

A preparation method for titanium-based amorphous spherical powder is disclosed, a titanium-based brazing filler metal in this solution includes Ti, Zr and M, where the M is a combination of two or three of Cu, Ni, Be, Ag, Sn, Si, Hf and Al, and a total mass percentage of Ti and Zr in the titanium-based brazing filler metal is greater than 50%; specifically, in Example 1, Ti and Zr are combined with Cu and Ni, and mass percentages of various elements are Ti 37.5%, Zr 37.5%, Cu 15% and Ni 10%; and a relative melting point offset J of titanium-based alloy is ≥0.2.

Specifically, a calculation formula for the relative melting point offset is as follows:

$$J = \frac{{T}_{m}^{mix} - {T}_{m}}{{T}_{m}^{mix}}$$

Tₘ is a melting point of the alloy, and Tₘ^{mix} is a mixed melting point; a calculation formula of Tₘ^{mix} is

$${T}_{m}^{mix} = {\sum }_{i = 1}^{n} {n}_{i} {T}_{m}^{i} ,$$

where nᵢ is a molar fraction of an i^{th} element in a multi-element alloy system; and Tₘⁱ is a melting point of the i^{th} element in the multi-element alloy system.

In Example 1, Ti—Zr—Cu—Ni is taken as an example, the components include Ti37.5Zr37.5Cu15Ni10 (in percentage by mass), molar fractions are Ti48.93Zr25.68Cu14.75Ni10.64, a liquidus temperature of the alloy is 848° C., and a calculation formula is as follows:

$$J = \frac{\begin{matrix}0.4893 \times 1668 + 0.2568 \times 1852 + 0.1475 \times 1083 + 0.1064 \times 1453 - \\ 848\end{matrix}}{0.4893 \times 1668 + 0.2568 \times 1852 + 0.1475 \times 1083 + 0.1064 \times 1453} = 0.472 > 0.2$$

Therefore, raw material composition of the titanium-based brazing filler metal in this solution can meet raw material requirements for preparing amorphous spherical powder from the alloy.

In this solution, when preparing the amorphous spherical powder of the titanium-based brazing filler metal, the titanium-based brazing filler metal is treated by plasma rotating electrode process (PREP) atomization specifically, argon and helium are used as a protective gas for the PREP atomization, and a concentration of argon in the protective gas is 10-50%, and is specifically 10% in Example 1.

In this solution, the titanium-based brazing filler metal is a bar material with a diameter of 60-90 mm, a rotation velocity of the bar material for the PREP atomization is greater than 25500 rpm, and a linear velocity of the bar material for the PREP atomization is greater than 80 m/s. Further, gas atomization of the titanium-based brazing filler metal is specifically completed in a box body, and argon and helium are mixed before being filled into the box body; and the bar material is atomized under conditions including a plasma power of 80 kW and a feed velocity of 0.8 mm/s.

The PREP atomization is a commonly used centrifugal atomization technology for producing high-purity spherical titanium powder, and its basic principle is as follows: in a protective gas environment, an end face of a consumable electrode is melted into a liquid film by a plasma arc, and is thrown out at high velocity to form droplets under the action of a rotational centrifugal force, and then the droplets are spheroidized and condensed into spherical powder under the action of surface tension.

However, formation of amorphous powder directly depends on a critical cooling rate R_{c} when melt alloy is cooled. When an external cooling rate R is higher than the critical cooling rate R_{c} of the alloy and when the melt alloy reaches a solidification temperature, its internal atoms are frozen near a position where they are in a liquid state before they are crystallized, thereby forming an amorphous solid with an amorphous structure; and that is, when the external cooling rate is high enough, the alloy can form the amorphous powder. A model of an amorphous alloy system R_{c} of the alloy is as follows:

$${R}_{c} = Z \frac{{k}_{B} {T}_{m}^{2}}{{a}^{3} {η}_{T = {T}_{m}}} exp ( \frac{Δ G}{RT} )$$

where Z is a thermodynamic factor parameter, Z=2×10⁻⁶;
Tₘ is a set temperature, which is calculated as follows;

$${T}_{m} = {\sum }_{i = 1}^{n} {n}_{i} {T}_{m}^{i}$$

nᵢ is content of an i^{th} element, and Tₘⁱ is a melting point of the i^{th} element;
a is an average atomic diameter;
η represents viscosity of metallic glass;

$$η ( T ) = {10}^{- 3.3} exp ( \frac{3.34 {T}_{m}}{T - {T}_{g}} )$$

ΔG is a free energy difference between solid and liquid states;

$$Δ G = Δ H - T Δ S$$

ΔH and ΔS represent mixing enthalpy and mixing entropy, respectively.

In the titanium-based alloy Ti37.5Zr37.5Cu15Ni10 (in percentage by mass) used in this solution, Cu and Ni are adjacent fourth-period transition elements, Ti and Zr are adjacent same-family transition elements, Cu and Ni are regarded as a kind of elements, and the atomic diameter is equal to an average value of atomic diameters of the two elements; and Ti and Zr are regarded as a kind of atoms, and the atomic diameter is equal to an average value of atomic diameters of the two atoms. A quaternary alloy system is converted into a binary alloy system, N is taken as 4, ΔH and ΔS of the quaternary alloy system are calculated, and a theoretical value of R_{c} is calculated to be 1.66×10⁴ K/s. Therefore, theoretically, the cooling rate R of the alloy powder must be higher than 1.66×10⁴ K/s to prepare the amorphous spherical powder of titanium-based alloy Ti37.5Zr37.5Cu15Ni10.

Specifically, thermal equilibrium conditions of molten droplets (specifically referring to droplets formed after the titanium-based alloy is melted in this solution) are as follows: during solidification, the molten droplets release heat to an ambient environment, and a thermal equilibrium formula is as follows:

$$- V * ρ * {C}_{p} * \frac{{dT}_{d}}{dt} = h * A * ( {T}_{d} - {T}_{f} ) \qquad ( 1 )$$

where V is a droplet volume (m³), ρ is a density (kg/m³), Cₚ is specific heat (J/(kg·K)), h is a heat transfer coefficient (w/(m·K)), A is a surface area of the droplet (m²), T_{d} is a molten droplet temperature, and T_{f} is a gas temperature. When a cooling rate

$$\frac{d \text{?}}{dt}$$

$$\text{?} \text{indicates text missing or illegible when filed}$$

of the molten droplet is greater, it is easier for the titanium-based alloy to form the amorphous alloy.

The powder prepared by the PREP atomization has good sphericity, and the formula (1) can be expressed as:

$$\frac{{dT}_{d}}{dt} = \frac{h * A}{V * ρ * {C}_{p}} * ( {T}_{d} - {T}_{f} ) = - \frac{6 h}{ρ * {C}_{p} * d} * ( {T}_{d} - {T}_{f} ) \qquad ( 2 )$$

It can be seen from the formula (2), when the heat transfer coefficient h is greater, a molten droplet diameter d becomes smaller, the cooling rate increases, and an amorphous forming ability of the titanium-based powder becomes stronger. The rotation velocity of the PREP atomization increases, and the molten droplet diameter d becomes smaller.

The heat transfer coefficient h denotes mutual heat transfer between the high-temperature molten droplet and the gas, and a calculation formula is as follows:

$$h = \frac{{λ}_{m}}{d} ( 2. + 0.6 \sqrt{{R}_{e}} * \sqrt[3]{{P}_{r}} ) \qquad ( 3 )$$

where λₘ is a thermal conductivity coefficient of the gas (W/m·K), Pᵣ is a Planck constant of the gas (Kg·m²/S); and Rₑ is a Reynolds number. It can be seen that the thermal conductivity coefficient of the protective gas in the box significantly affects the heat transfer coefficient h.

In the prior art, a method of using a certain gas alone as a protective gas has certain defects. For example, when the applicant uses nitrogen or hydrogen alone, the titanium-based brazing filler metal reacts with nitrogen, hydrogen and other gases to generate TiH or TiN, which will result in failure in preparation of titanium-based amorphous powder from the titanium-based alloy; when the applicant uses argon alone, due to a relatively low thermal conductivity coefficient of argon (the thermal conductivity coefficient of argon is 1.62×10⁻² W/(m·K)), cooling rate requirements for preparing the titanium-based amorphous powder cannot be met; and when the applicant tried using helium alone as the protective gas, normal production could not be achieved due to failure of plasma arcing.

Therefore, in this solution, argon and helium are selected as the protective gas; and the thermal conductivity coefficient of a mixed gas is calculated according to the following calculation formula:

$${λ}_{m} = \frac{\sum {λ}_{i} {y}_{i} {M}_{i}^{1 / 3}}{\sum {y}_{i} {M}_{i}^{1 / 3}} \qquad ( 4 )$$

where λₘ is the thermal conductivity coefficient of the mixed gas (W/m·K);
λᵢ is a thermal conductivity coefficient of the i^{th} element in the mixed gas;
yᵢ is a molar fraction of the i^{th} element in the mixed gas; and
Mᵢ^{1/3} is a molar mass of the i^{th} element in the mixed gas (kg/kmol).

In Example 1, the concentration of argon in the protective gas is specifically 10%, that is, Ar:He=1:9; in this case, the thermal conductivity coefficient of the mixed gas is calculated as follows (specifically, the thermal conductivity coefficient of argon being 1.62×10⁻² W/(m·K), the thermal conductivity coefficient of helium (He) being 5.79×10⁻² W/(m·K), and a mixing ratio of the two are substituted into the formula (4) for calculation):

$${λ}_{m} = \frac{1.62 \times {10}^{- 2} \times 0.1 \times {40}^{1 / 3} + 5.79 \times {10}^{- 2} \times 0.9 \times {4}^{1 / 3}}{0.1 \times {40}^{1 / 3} + 0.9 \times {4}^{1 / 3}} = 3.53 \times {10}^{- 2}$$

In this way, λₘ=3.53×10⁻² W/(m·K) can be substituted into the formula (3) to calculate the heat transfer coefficient h.

Further, the Reynolds number Rₑ in the formula (3) can be calculated by the following formula:

$${R}_{e} = \frac{U * {ρ}_{g} * d}{{μ}_{g}} \qquad ( 5 )$$

in the formula (5), ρ_{g} is a density of the gas, μ_{g} is a dynamic viscosity, d is the droplet diameter, and U is a relative velocity between the droplet and the gas.

According to the formula (3) and the formula (5), the following formula can be obtained:

$$h = \frac{2. {λ}_{m}}{d} + 0.6 {λ}_{m} \sqrt{\frac{U * {ρ}_{g}}{{μ}_{g} * d}} * \sqrt[3]{{P}_{r}} \qquad ( 6 )$$

According to the formula (2) and the formula (6), the following formula can be obtained:

$$\vert \frac{{dT}_{d}}{dt} \vert = \frac{6}{ρ * {C}_{p}} * ( {T}_{d} - {T}_{f} ) * ( \frac{2. {λ}_{m}}{{d}^{2}} + 0.6 \frac{{λ}_{m}}{d} \sqrt{\frac{{ρ}_{g} U}{{μ}_{g} d}} * \sqrt[3]{{P}_{r}} \qquad ( 7 )$$

In this solution, the titanium-based brazing filler metal is a bar material with a diameter of 60-90 mm, the rotation velocity of the bar material for the PREP atomization is greater than 25500 rpm, and the linear velocity of the bar material for the PREP atomization is greater than 80 m/s.

Testing values of each data in the formula are as follows:

| Parameter | Value | |
|---|---|---|
| Density, p/(kg/m³) | 5.82 × 10³ | |
| Specific heat Cₚ/J/((kg · K) | 845 | |
| Molten droplet temperature T_{d}/(K) | 1323 | (1049.85° C.) |
| Gas temperature T_{f}/(K) | 298 | (24.85° C.) |

| | |
|---|---|
| Thermal conductivity coefficient λₘ/(m · K) | 3.53 × 10⁻² |
| Droplet diameter d/(m) | 70 × 10⁻⁶ |
| Gas density ρ_{g}/(kg/m³) | 1.785 × 10⁻³ |
| Linear velocity (relative velocity between the | 80 |
| droplet and the [symbol] | |
| Dynamic viscosity μ_{g}/(m²/s) | 7.5 × 10⁻⁴ |
| Planck constant Pᵣ | ⅔ |

[symbol]

indicates data missing or illegible when filed

The cooling rate R obtained by substituting the above values into the formula (7) is 6.35×10⁴ K/s, a theoretical value of R_{c} is 1.66×10⁴ K/s, and calculation results indicate that the actual cooling rate R is greater than the critical cooling rate R_{c} of amorphous formation. Therefore, in this solution, the PREP atomization (argon and helium are mixed as the protective gas at a ratio of 1:9, the titanium-based brazing filler metal is a bar material with a diameter of 60-90 mm, and the linear velocity of the bar material is greater than 80 m/s) is adopted to prepare the titanium-based amorphous spherical powder with a powder particle size of 70×10⁻⁶ m (i.e., 70 μm).

### Comparative Example 1

This comparative example is basically the same as Example 1, and the difference lies in that, in this comparative example, argon is used as the protective gas when the titanium-based amorphous powder is prepared by means of the PREP atomization of the prior art.

In this comparative example, 100% argon is used as the protective gas, the thermal conductivity coefficient λₘ is taken as 1.62×10⁻² W/(m·K) and substituted into the above formula for calculation, the cooling rate of TiZrCuNi is 1.03×10⁴ K/s, and the actual cooling rate R is less than the critical cooling rate R_{c} for amorphous formation, indicating that the conditions for the amorphous formation are not met, and the titanium-based amorphous powder cannot be prepared.

### Experimental Example 1: Scanning Electron Microscope Detection of Morphology of the Titanium-Based Amorphous Powder Prepared

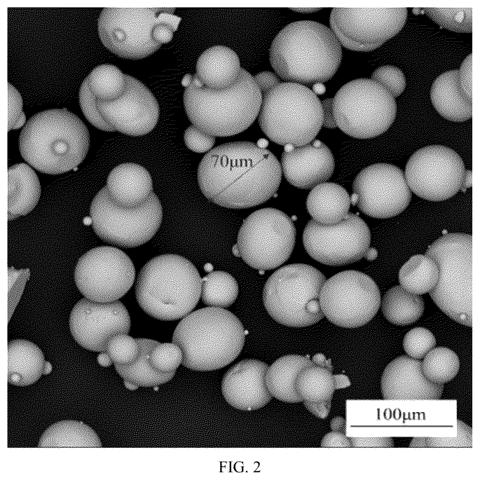

A scanning electron microscope (SEM) (for reference, the scanning electron microscope in this solution is purchased from Phenom-World of the United States, with a model of PHENOM XL) is used for scanning the alloy powder prepared in Example 1 and Comparative Example 1, and SEM results of the alloy powder obtained in Example 1 are shown in FIG. 2.

Experimental data indicate that the alloy powder prepared by the applicant according to parameter settings in Example 1 above is basically the titanium-based amorphous spherical powder, and its diameter is at around 70 μm (as shown in FIG. 2).

The alloy powder obtained in Comparative Example 1 is crystalline powder.

### Experimental Example 2: Analysis of Powder Phases Through a Bruker Diffractometer

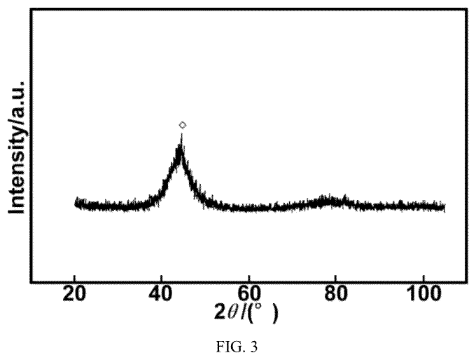

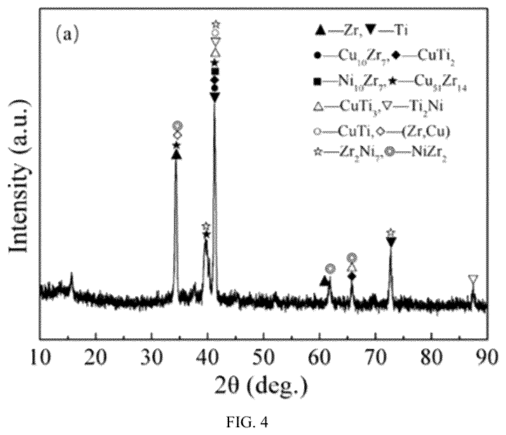

Phase compositions of the alloy powder obtained in Example 1 and Comparative Example 1 are analyzed by means of than Bruker diffractometer, and screenshots of an obtained XRD spectrogram are shown in FIGS. 3 and 4.

The XRD spectrogram of the TiZrCuNi brazing filler metal in Example 1 is shown in FIG. 3, and an obvious steamed bun peak can be observed in the XRD spectrogram of the titanium-based amorphous powder prepared in Example 1 of this solution, indicating that the powder has become amorphous during cooling and has a high degree of amorphism.

The XRD spectrogram of the TiZrCuNi brazing filler metal in Comparative Example 1 is shown in FIG. 4, which exhibits a plurality of sharp crystalline diffraction peaks, the diffraction peaks are widened in a curve range of 2θ=30°-45°, interference exists between the crystalline phase diffraction peaks, and a corresponding relationship between a crystalline phase and the diffraction peak is affected. This indicates that the alloy powder obtained in Comparative Example 1 is crystalline and has an intermetallic compound phase. A Ti—Zr—Cu—Ni crystalline brazing filler metal prepared in Comparative Example 1 includes Ti and Zr matrix phases, a solid solution phase Zr and a complex crystalline phase Cu, and crystalline phases include Cu₁₀Zr₇, CuTi₂, Ni₁₀Zr₇, Cu₅₁Zr₁₄, CuTi₃, Ti₂Ni, CuTi, Zr₂Ni₇, NiZr₂ and the like.

To sum up, according to this solution, argon and helium are used in combination as the protective gas, thereby effectively increasing the cooling velocity required by the titanium-based amorphous powder that can be achieved in this process and thus significantly improving the preparation success rate and purity of the titanium-based amorphous powder. Further, through long-term experimental optimization, the applicant has defined the concentration of argon in the protective gas to be 10-50%, which not only ensures the formation of the titanium-based amorphous spherical powder from the titanium-based brazing filler metal, but also significantly reduces a cost of the protective gas, thereby improving production efficiency.

Further, according to this solution, by limiting the diameter and rotation velocity of the bar material prepared from the titanium-based brazing filler metal, equipment requirements and energy consumption conditions for preparing the titanium-based amorphous spherical powder by the PREP atomization can be effectively lowered, thereby not only enhancing production safety, but also further reducing production costs and improving overall production efficiency.

What is described above is merely Example 1 of the present disclosure, and common general knowledge such as well-known specific technical schemes and/or characteristics in the solution is not described too much herein. It should be noted that those skilled in the art may further make several transformations and improvements on the premise of not deviating from the technical scheme of the present disclosure, and these transformations and improvements should fall within the scope of protection of the present disclosure without affecting the implementation effect of the present disclosure and the practicability of the patent. The protection scope of the present disclosure shall be determined by the terms of the claims, and the specific embodiments and other records in the specification can be used to interpret the content of the claims.

What is claimed is:

1. A preparation method for titanium-based amorphous spherical powder, comprising treating a titanium-based brazing filler metal by means of plasma rotating electrode process (PREP) atomization, wherein argon and helium are used as a protective gas for the PREP atomization.

2. The preparation method for titanium-based amorphous spherical powder according to claim 1, wherein a concentration of argon in the protective gas is 10-50%.

3. The preparation method for titanium-based amorphous spherical powder according to claim 2, wherein gas atomization of the titanium-based brazing filler metal is specifically completed in a box body, and the argon and helium are mixed before being filled into the box body.

4. The preparation method for titanium-based amorphous spherical powder according to claim 3, wherein the titanium-based brazing filler metal is a bar material with a diameter of 60-90 mm.

5. The preparation method for titanium-based amorphous spherical powder according to claim 4, wherein a rotation velocity of the bar material for the PREP atomization is greater than 25500 rpm.

6. The preparation method for titanium-based amorphous spherical powder according to claim 4, wherein a linear velocity of the bar material for the PREP atomization is greater than 80 m/s.

7. The preparation method for titanium-based amorphous spherical powder according to claim 6, wherein the titanium-based brazing filler metal comprises Ti, Zr and M, where the M is a combination of two or three of Cu, Ni, Be, Ag, Sn, Si, Hf and Al, and a relative melting point offset J of the titanium-based alloy is ≥0.2.

8. The preparation method for titanium-based amorphous spherical powder according to claim 7, wherein a total mass percentage of Ti and Zr in the titanium-based brazing filler metal is greater than 50%.
